(19) United States
(12) Patent Application Publication
(10) Pub. No.: US 2011/0019102 A1
(43) Pub. Date: Jan. 27, 2011

(54) OUTPUT DATA SWITCHING APPARATUS, OUTPUT DATA SWITCHING METHOD, OUTPUT DATA SWITCHING SYSTEM AND PROGRAM FOR OUTPUT DATA SWITCHING APPARATUS

(75) Inventor: Koichi Katsuya, Fujimi (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa (JP)

(21) Appl. No.: 12/935,130

(22) PCT Filed: Mar. 28, 2008
(86) PCT No.: PCT/JP2008/056109

§ 371 Date: Sep. 28, 2010

(51) Int. Cl. H04N 5/44

(52) U.S. Cl. 348/725; 348/E05.096

(57) ABSTRACT

There is provided an output data switching apparatus for remarkably alleviating user's uncomfortable feeling caused by an output data switching. The output data switching apparatus, as an output data switching apparatus 20 for switching an output of an output data made of at least one of a sound component and a video component from a first output data being output to a second output data, includes relevant information outputting elements (82 to 84, 87 to S9, 86) for outputting relevant information associated with the second output data together with the first output data being output based on an output form of the first output data and an output form of the second data, and switching element S5 for switching the output from the first output data to the second output data after the relevant information is output.

### TECHNICAL FIELD

The present invention relates to an output data switching apparatus and others for switching data being output.

### BACKGROUND ART

There has been conventionally disclosed a technique for, at the time of automatically switching contents from various information devices including broadcast receiving apparatuses such as a radio set and a television set and playback apparatuses such as CD (Compact Disc) player and DVD (Digital Versatile Disc) player, alleviating uncomfortable feeling given to a user. For example, there is disclosed a content presenting apparatus which is provided with content selecting means for selecting an accumulative content for a switching destination from among accumulative contents being accumulated based on whether a broadcast content being received is a television content or radio content (Patent Literature 1).

Patent Literature 1: Japanese Patent Application Laid-Open No. 2006-270773

### SUMMARY OF THE INVENTION

### Problem to be Solved by the Invention

However, there is a problem, in the aforementioned conventional invention, that even if contents having a similar form are selected in consideration of whether a broadcast content being received includes an image, switching to the content selected at the time of switching is performed at the same time as a broadcast starting, and thus user's unintentional uncomfortable feeling is still present.

The present invention has been made in terms of the above problem, and an object thereof is to remarkably alleviate user's uncomfortable feeling during an output data switching.

### Means for Solving the Problem

In order to solve the above problem, the invention according to claim 1 relates to an output data switching apparatus for switching an output of output data made of at least one of a sound component and a video component from a first output data being output to a second output data, comprising:

relevant information outputting means for outputting relevant information associated with the second output data together with the first output data being output based on an output form of the first output data and an output form of the second output data; and

switching means for switching the output from the first output data to the second output data after the relevant information is output.

The invention according to claim 14 relates to an output data switching method of switching an output of output data made of at least one of a sound component and a video component from a first output data being output to a second output data, comprising:

a first output data's output form deicing step of deciding an output form of the first output data;

a second output data's output form deciding step of deciding an output form of the second output data;

a relevant information outputting step of outputting relevant information associated with the second data together with the first output data being output based on decision results of the first output data's output form deciding step and the second output data's output form deciding step; and

a switching step of switching the output from the first output data to the second output data after the relevant information is output.

The invention according to claim 16 relates to an output data switching system, comprising:

the output data switching apparatus according to claim 1; and

a plurality of output data source apparatuses as a source for supplying an output data,

wherein an output data from the output data source apparatus is switched by the output data switching apparatus, and is output.

The invention according to claim 17 relates to a program for an output data switching apparatus, causing a computer contained in the output data switching apparatus according to claim 1 to function as the relevant information outputting means and the switching means.

### BRIEF DESCRIPTION OF DRAWINGS

FIG. 1 is a block diagram showing one example of a schematic configuration of an output data switching system according to a first embodiment of the present invention;

FIG. 2 is a flowchart showing exemplary operations of an output data switching apparatus having the configuration example of FIG. 1;

FIG. 3 is a block diagram showing one example of a schematic configuration of an output data switching system according to a second embodiment of the present invention;

FIG. 4 is a flowchart showing exemplary operations of an output data switching apparatus having the configuration example of FIG. 3;

FIG. 5 is a block diagram showing one example of a schematic configuration of an output data switching system according to a third embodiment of the present invention; and

FIG. 6 is a flowchart showing exemplary operations of an output data switching apparatus having the configuration example of FIG. 5.

### DESCRIPTION OF REFERENCE NUMERALS

1, 2, 40: Output data switching system

10: Content supplying apparatus

11: Digital TV tuner

12: Digital radio tuner

13: DVD player

14: CD player

20, 20A: Output data switching apparatus

21: Source managing part

22: Output controlling part

23: Output deciding part

24: Sound output switching part

25: Video output switching

26: Message inserting part

27: Boundary deciding part

30: Outputting apparatus

41: Tuner part

42: DB part

43: Playback part

47: Sound part

48: Video part

### DESCRIPTION OF BEST EMBODIMENTS FOR CARRYING OUT THE INVENTION

Embodiments according to the present invention will be described below with reference to the accompanying drawings.

### First Embodiment

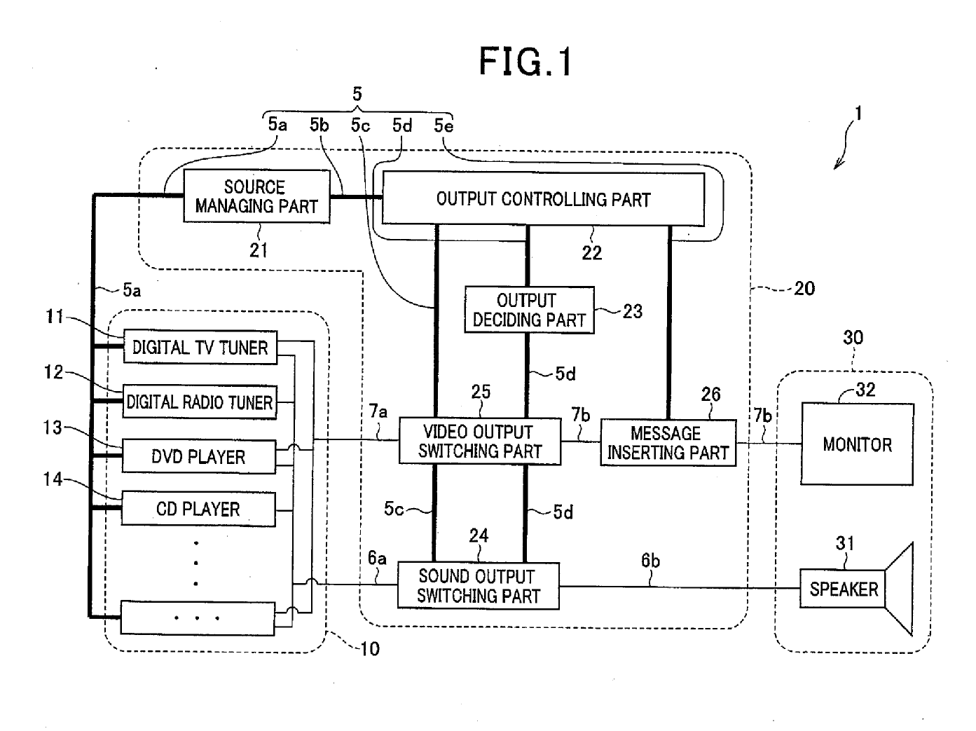

There will be first described a schematic configuration and function of an output data switching system according to a first embodiment with reference to FIG. 1.

FIG. 1 is a block diagram showing one example of the schematic configuration of the output data switching system according to the first embodiment.

As shown in FIG. 1, the output data switching system 1 is configured with a content supplying apparatus 10 for supplying contents such as sound and video, an output data switching apparatus 20 for switching output data such as contents, an outputting apparatus 30 for outputting sound and video, and the like.

In this configuration, the content supplying apparatus 10 is connected to the output data switching apparatus 20 via control lines 5 for exchanging information between respective apparatuses, a sound data line 6a for transmitting sound-component data, and a video line 7a for transmitting video-component data.

The outputting apparatus 30 is connected to the output data switching apparatus via a sound data line 6b and a video line 7b.

The content supplying apparatus 10 is configured with a digital TV (Television) tuner 11 for receiving a radio wave of terrestrial digital broadcasting or satellite digital broadcasting and extracting both a sound component and a video component, program information or the like, a digital radio tuner 12 for receiving a radio wave of terrestrial digital sound broadcasting or satellite digital sound broadcasting and extracting a sound component, program information or the like, a DVD player 13 for playing back contents such as movie, a CD player 14 for playing back contents such as music, and the like. The content supplying apparatus 10 may include a playback apparatus for playing back contents accumulated in a hard disc, a SSD (Solid State Drive) using a flash memory as storage medium, and the like.

In this configuration, each tuner or player in the content supplying apparatus 10 is connected to the output data switching apparatus 20 via the control lines 5.

Then, output data such as contents made of at least one of a sound component and a video component is supplied to the output data switching apparatus 20 from each apparatus such as the digital TV tuner 11 in the content supplying apparatus 10. For example, the output data is supplied to the output data switching apparatus 20 in an output form such as sound-only content, video-only content or sound-and-video content.

The output data switching apparatus 20 switches from first output data such as content being currently output to second output data such as content to be next output. For example, in the case that a TV broadcast program is reserved but does not yet start to be broadcast and thus a user is currently listening to music or the like from the CD player 14, the first output data is output data from the CD player 14 and the second output data is output data from the digital TV tuner 11. In this case, the output form of the first output data is output data made of only a sound component, and the output form of the second output data is output data made of both a sound component and a video component.

The outputting apparatus 30 is configured with a speaker 31 for outputting sound such as music or narration, and a monitor 32 for displaying videos including still images and frame images such as animation or slide show, and the speaker 31 is connected to the sound data line 6 and the monitor 32 is connected to the video line 7.

A detailed configuration and function of the output data switching apparatus 20 will be described below.

The output data switching apparatus 20 is configured with a source managing part 21 for controlling the content supplying apparatus 10 as a source of contents, an output controlling part 22 for controlling output data based on the source managing part 21 or controlling the entire output data switching apparatus 20, an output deciding part 23 for deciding an output form of output data being output, a sound output switching part 24 for switching sound data in the sound data line 6a, a video output switching part 25 for switching video data in the video line 7a, and a message inserting part 26 for inserting message data in the video data in the video line 7b and the like.

In this configuration, the source managing part 21 and the content supplying apparatus 10 are connected via the control line 5a, the source managing part 21 and the output controlling part 22 are connected via the control line 5b, the output controlling part 22, the sound output switching part 24 and the video output switching part 25 are connected via the control line 5c, the output controlling part 22, the output deciding part 23, the sound output switching part 24 and the video output switching part 25 are connected via the control line 5d, and the output controlling part 22 and the message inserting part 26 are connected via the control line 5e.

Further, the sound output switching part 24 is connected to each apparatus in the content supplying apparatus 10 via a separate sound data line 6a. The video output switching part 25 is connected to each apparatus in the content supplying apparatus 10 via a separate video data line 7a. The output side of the sound output switching part 24 is connected to the speaker 31 via the sound data line 6b. The video output switching part 25, the message inserting part 26 and the monitor 32 are connected via the video data line 7b.

The source managing part 21 has a CPU (Central Processing Unit), a RAM (Random Access Memory), a ROM (Read Only Memory) and the like, acquires information on a playback state of each apparatus in the content supplying apparatus 10 or electronic program information such as EPG (Electronic Program Guide) from the digital TV tuner 11 or the like, outputs the information to the output controlling part 22, and controls each apparatus in the content supplying apparatus 10 based on the output controlling part 22.

The output controlling part 22 has the CPU, the RAM, the ROM and the like, exchanges information with each part in the output data switching apparatus 20, controls each apparatus in the content supplying apparatus 10 via the source managing part 21, and controls sound data or video data via the sound output switching part 24, the video output switching part 25 or the message inserting part 26.

The output deciding part 23 has the CPU, the RAM, the ROM and the like, and acquires and analyzes information on the states of the sound output switching part 24 and the video output switching part 25. For example, the output deciding part 23 analyzes a sound volume level or frequency component of sound data in the sound output switching part 24 in addition to the state of the output side of the sound output switching part 24. The output deciding part 23 analyzes a luminance signal and a color signal of video data for the video output switching part 25.

The sound output switching part 24 controls ON/OFF, sound volume or frequency filtering of the sound data based on an instruction from the output controlling part 22.

The video output switching part 25 controls ON/OFF, luminance or color tone of the video data based on an instruction from the output controlling part 22.

The message inserting part 26 mainly superimposes information, such as message, different from the output data from the content supplying apparatus 10 on the video data from the video output switching part 25.

The processings in the source managing part 21 and the like may be performed by a programmable logic device (PLD), a customized LSI (Large Scale Integration) or the like. In a switching circuit or the like, the processings maybe performed in a combination of electronic devices such as transistor.

The output data switching apparatus 20 also functions as one example of relevant information outputting means for outputting relevant information associated with the second output data together with the first output data being output based on the output form of the first output data and the output form of the second output data. For example, for the output form of the first output data, the output deciding part 23 decides the output form of the first output data based on the information from the sound output switching part 24 and the video output switching part 25. For the output form of the second data, the source managing part 21 or the like may decide the output form of the first output data based on the information collected from the content supplying apparatus 10 via the control line 5a.

Since the output form of the second output data such as content is previously known when the content is reserved to be played back, the output controlling part 22 or the like may decide the output form of the second output data based on the information on the output form of the output data accumulated in the source managing part 21 or the like. Further, the output controlling part 22 or the like may decide also the output form of the first output data based on the information on the output form of the accumulated output data.

Then, after the relevant information associated with the second output data is output, the output controlling part 22, the sound output switching part 24 and the video output switching part 25 function as one example of switching means for switching the output from the first output data to the second output data.

The operations of the output data switching apparatus 20 will be described below with reference to the drawing.

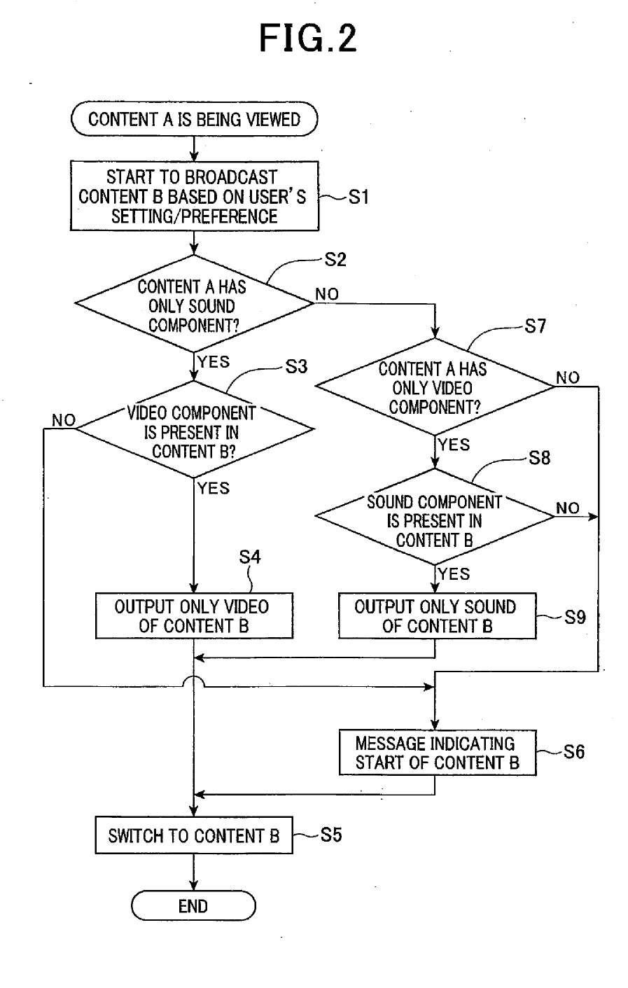

FIG. 2 is a flowchart showing exemplary operations of the output data switching apparatus 20.

It is first assumed that the user is listening to a content A as one example of the first output data. For example, the user is listening to music data played back by the CD player 14 in a car or the like. Further, a content 1B as one example of the second output data is broadcast data in a user-reserved television broadcast program, for example. When the content A is music data, it may be a series of music numbers made of collected pieces of music or narration, or a single music number. The content B may be a program having commercial messages inserted therein or a content made of collected different programs in the case of broadcast data. In the case of movie, TV drama or documentary program, its content may be a series of certain theme, actor or director. In other words, the content may be a collection of output data having a common output form.

When the user is listening to the first output data as described above, the output controlling part 22 detects whether it can output the second output data as one example of output possibility deciding means (step S1). For example, the output controlling part 22, as one example of the output possibility deciding means, decides whether it can output the second output data based on a reservation. Specifically, the output controlling part 22 detects that the user-reserved broadcast content B has started or is soon starting to be broadcasted by the information from the source managing part 21 or a timer inside the output controlling part 22 itself.

Next, the output controlling part 22, as one example of output form deciding means, decides whether the output form of the first output data is only the sound component (step S2). For example, the output controlling part 22 decides whether the output form of the content A being currently output is only the sound component based on the information from the output deciding part 23.

When the output form of the first output data is only the sound component (step S2; YES), the output controlling part 22, as one example of different component presence deciding means, decides whether the video component different from the sound component is present in the second output data (step S3). For example, when the output form of the content A is only the sound component, the output controlling part 22 decides whether the content B has the video component.

When the video component is present in the second output data (step S3; YES), the output controlling part 22 outputs the second output data by only the video component as one example of the relevant information associated with the second data (step S4). For example, the output controlling part 22 outputs only the video data from the digital TV tuner 11 to the video output switching part 25 while outputting the sound data from the CD player 14 to the sound output switching part 24. In other words, the output controlling part 22 displays only the video of the content B from the digital TV tuner 11 on the monitor 32 while the music from the CD player 14 is being output from the speaker 31.

After a while, the output controlling part 22 completely switches the output to the second output data (step S5). For example, the output controlling part 22 starts to output the sound component of the content B and completely transits to the content B.

Next, when the video component is not present in the second output data (step S3; NO), the output controlling part 22 outputs a message indicating that the second output data can be output (step S6). For example, the output controlling part 22 displays a message indicating that the content B has started or is soon starting on the monitor 32 via the message inserting part 26. Specifically, the output controlling part 22 outputs the message in the form of pop-up or ticker so as not to hinder the content A from being viewed. One example of the possibility of outputting the second output data may be indicated by a message indicating that the time to start the broadcasting is being approaching or has been reached, or indicating that the time to play back a reserved content is being approached or has been reached.

After a while, the output controlling part 22 switches the output to the second output data (step S5).

On the other hand, when the output form of the first output data is not only the sound component (step S2; NO), the output controlling part 22 decides whether the output form of the first output data is only the video component (step S7). For example, since the output form of the content A is not the sound component alone but the video component alone like slide show or both the sound component and the video component like movie at this stage, the output controlling part 22 classifies the content A depending on only the video component or both the sound component and the video component.

When the output form of the first output data is only the video component (step S7; YES), the output controlling part 22, as one example of the different component presence deciding means, decides whether the sound component different from the video component is present in the second output data (step S8). For example, when the output form of the content A is only the video component, the output controlling part 22 decides whether the content B has the sound component.

Next, when the sound component is present in the second output data (step S8; YES), the output controlling part 22 outputs the second output data by only the sound component as one example of the relevant information associated with the second data (step S9). For example, when the content A is slide show or the like and the content B is broadcast programs, drama or the like, while the user is viewing the content A, the output controlling part 22 outputs only the sound component of the content B to the speaker 31.

After a while, the output controlling part 22 completely switches the output to he second output data (step S5). For example, the output controlling part 22 starts to output the video component of the content B and completely transits to the content B.

Next, when the output form of the first output data is both the sound component and the video component (step S7; NO) or when the sound component is not present in the second output data (step S8; NO), the output controlling part 22 outputs a message indicating that the second output data can be output (step S6). Specifically, the output controlling part 22 outputs the message in the form of pop-up or ticker so as not to hinder the content A from being viewed. For example, the output controlling part 22 inserts a message indicating that the content B has started or is soon starting into the video data via the message inserting part 26 and displays it on the monitor 32.

After a while, the output controlling part 22 switches the output to the second output data (step S5).

As stated above, the output controlling part 22 functions as one example of the output form deciding means for deciding whether the output form of the first output data is a single component in step S2 and step S6, and functions as one example of the different component presence deciding means for deciding whether a different component from the single component is present in the second output data in step S3 and step S7.

The output controlling part 22 functions as examples of the output form deciding means and the different component presence deciding means, and outputs the relevant information associated with the second output data such that respective components of the output forms of the first output data and the second output data do not superimpose on each other.

When the output form of the second output data is where a remaining component obtained by removing the component of the first output data from the components of the second output data is present, the output controlling part 22 may output only the remaining component of the second output data as one example of the relevant information outputting means. Thus, the relevant information associated with the second output data can be output such that the respective components of the output forms of the first output data and the second output data do not superimpose on each other.

With the above configuration, the information associated with the second output data such as the video component alone of the second output data, the sound component alone thereof, or a message is previously notified while the first output data is being output before the second output data such as the content B is output, and thus the output data is not suddenly switched, thereby remarkably alleviating user's uncomfortable feeling.

The output controlling part 22 can function as examples of the output form deciding means and the different component presence deciding means to notify the relevant information of the output data such that the respective components of the output forms of the first output data and the second output data do not superimpose on each other, which does not directly hinder the content or the like which is being viewed or listened by the user, thereby remarkably alleviating user's uncomfortable feeling.

Then, the output controlling part 22 outputs a message indicating that the second output data can be output when the second output data can be output based on a decision as to whether the second output data can be output, and previously notifies that the content B has starts to be broadcasted as one example of the message indicating that the second output data can be output before switching the output data, thereby causing the user to recognize that the content B is starting, preventing unintentional switching, and remarkably alleviating user's uncomfortable feeling.

The present invention is not limited to the above embodiment and various modification can be made.

For example, in the present embodiment, the relevant information associated with the second output data is output such that the respective components of the output forms of the first output data and the second output data do not superimpose on each other, but even when the respective components of the output forms superimpose on each other, the output controlling part 22 may, as one example of the relevant information outputting means, output either the sound component or the video component constituting the second output data as one example of the relevant information associated with the second output data. For example, when the content A as the first output data is news program and the content B as one example of the second output data is movie, the output controlling part 22 may superimpose only the sound of the movie as the content B on the news program while the user is viewing the news program as the content A. At this time, the output controlling part 22 gradually reduces the sound volume of the sound of the news program as the content A and gradually increases the sound volume of the sound of the movie of the content B. When the sounder are completely switched, the output controlling part 22 may switch the video of the news program as the content A with the video of the movie as the content B.

In this case, one component in the second output data is utilized to notify the user of the output of the relevant information of the second output data, and when the second output data has the output form of a single component, the output can smoothly transit to the second output data thereby remarkably alleviating user's uncomfortable feeling. Particularly when the second output data has the two-component output form made of the sound component and the video component, either one component is output and then the other component is output, thereby smoothly transiting to the second output data and remarkably alleviating user's uncomfortable feeling.

At least one of amplitude and frequency of the first output data is changed and thus the output controlling part 22 may output a message as one example of the message indicating that the second output data can be output. For example, the output controlling part 22 modulates a sound signal or a video signal by the sound output switching part 24, the video output switching part 25 or the message inserting part 26. For the sound signal, the output controlling part 22 may shift the frequency component of the sound signal to a high frequency area in a frequency area or to a low frequency area thereby changing musical scale, or may increase or decrease the sound volume for changing. For the video signal, the output controlling part 22 may change luminance or color tone. In this manner, the start of the second output data is notified by the change in the first output data. The output controlling part 22 may output non-harsh sound in addition to pop-up or ticker as one example of the message indicating that the second output data can be output.

In these cases, at least one of amplitude and frequency of the first output data is changed, that is, the first output data is changed so as not to hinder the output of the first output data from being viewed, which does not suddenly interrupt the first output data, thereby remarkably alleviating user's uncomfortable feeling.

The output controlling part 22 may, as one example of the relevant information outputting means, output either the sound component or the video component constituting the second output data as the relevant information and then further output the message indicating that the second output data can be output. For example, after step S4 or step S8, the output controlling part 22 may output the message indicating that the second output data can be output as in step S6.

In this case, the message indicating that the second output data can be output can be more accurately notified to the user and the user can more easily recognize that the output data is switched, thereby remarkably alleviating user's uncomfortable feeling.

The output controlling part 22 may decide whether the output form of the first output data is the single component, in the case of the single component, decides whether a different component from the single component is present in the second output data, and when the different component is not present, output the message indicating that the second output data can be output as one example of the relevant information outputting means.

For example, when the second output data has the sound component and the video component and the first output data also has the sound component and the video component, all the components of the second output data, that is, the sound component and the video component superimpose on the components of the first output data, and the message indicating that the second output data can be output is output by only the sound component or only the video component of the second output data such that the respective components of the output forms of the first output data and the second output data do not superimpose on each other.

In another case, when the second output data has only the sound component and the first output data has both the sound component and the video component or only the sound component, the sound component of the second output data may superimpose on the component of the first output data. When the second output data has only the video component and the first output data has both the sound component and the video component or only the video component, the sound component of the second output data may superimpose on the component of the first output data. Also in the cases, the output controlling part 22 outputs the message indicating that the second output data can be output.

In this case, particularly when the message cannot be notified by only the sound component or by only the video component of the second output data such that the respective components of the output forms of the first output data and the second output data do not superimpose on each other, the message indicating the switching of the second output data can be notified as one example of the second output data information so as not to hinder the first output data from being viewed, thereby remarkably alleviating user's uncomfortable feeling.

The output controlling part 22 or the like may, as one example of the output possibility deciding means, decide whether the second output data can be output based on the result obtained by retrieving the second output data capable of being output based on user's preference information.

In this case, it is possible to automatically retrieve contents which the user wants to view without reservation and to provide the latest information so as not to hinder user's viewing of the contents or the like.

For the timing of switching the output data, for example, the relevant information of the second output data is output about 30 seconds before the content B as one example of the second output data starts to be broadcasted, and may be completely switched to the content B or the like when the content B starts to be broadcasted unless there is a user's action such as switching request or denial.

In this case, since the user can view the content B or the like from the beginning, the user cannot miss the content B or the like, thereby remarkably alleviating user's uncomfortable feeling. Since the content B or the like has not started to be broadcasted as the relevant information of the second output data, a trailer or message for the content B is output.

The transition time until the first output data is completely switched to the second output data after the relevant information of the second output data is output is not limited to about 30 seconds, and may be any time which the user does not feel uncomfortable because the switching is too early or too late. Alternatively, the user may set the transition time.

When the output is switched after the content B starts to be broadcasted, the output controlling part 22 may store the content B in a storage device such as hard disc at the same time with the start of the broadcast of the content B, and may play back the content B from the beginning. Since the content B is played back a little behind the actual broadcasting, the output controlling part 22 may switch from the playback from the storage device to the output from the actual broadcasting when the actual broadcasting is caught up by the increased playback speed or while a commercial message is being broadcasted.

In this case, the user does not miss the content B or the like from the beginning and user's uncomfortable feeling can be remarkably alleviated. Although the switching form such as acoustic content selection for radio content is limited in the technique in Patent Literature 1, any combination of forms of the content A and the content B may remarkably alleviate user's uncomfortable feeling in the present embodiment containing its variants.

### Second Embodiment

Next, an output data switching system according to a second embodiment of the present invention will be described.

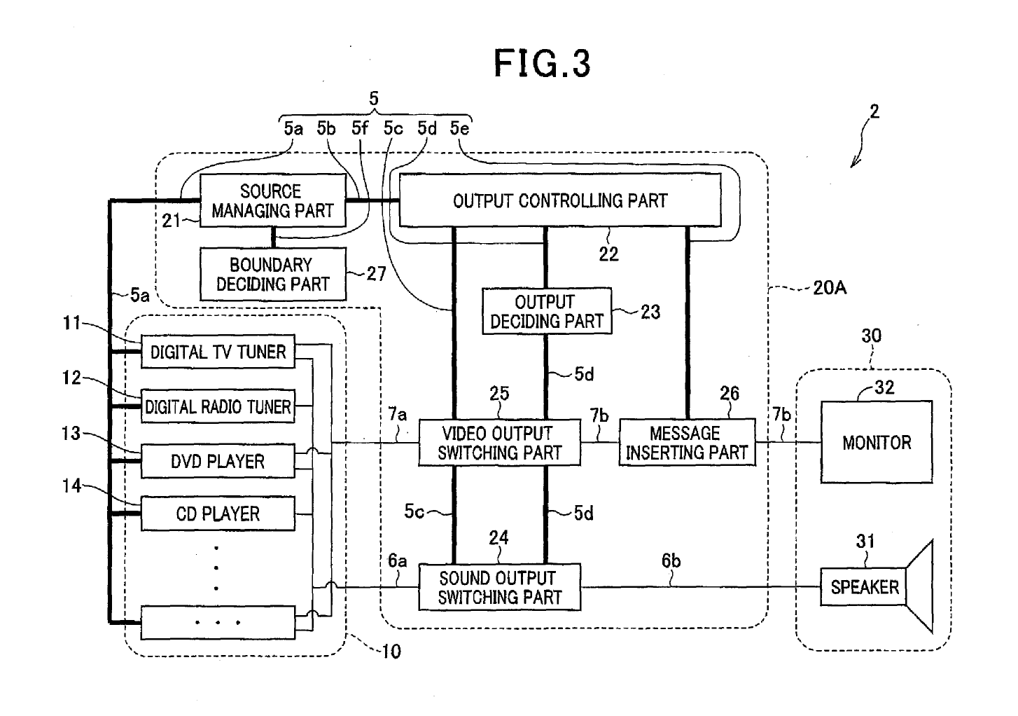

First, a schematic configuration of the output data switching system according to the second embodiment will be described with reference to FIG. 3. The same reference numerals are denoted to parts similar or corresponding to those in the first embodiment and only different configurations and operations will be described. Other embodiments and variants are the same.

FIG. 3 is a block diagram showing one example of the schematic configuration of the output data switching system according to the second embodiment. As shown in FIG. 3, the output data switching system 2 is configured such that a boundary deciding part 27 for deciding a boundary of the information associated with the content A as one example of the first output data is added to the source managing part 21 in the output data switching system 1 according to the first embodiment to form an output data switching apparatus 20A. Examples of the boundary of information include a boundary between music numbers, a boundary between music number and narration, an ending part of each music number, a part where a boundary between chapter information and index information of movie or the like is previously set, a part where the sound volume is reduced when the boundary is regarded separated by the reduced sound volume part, a boundary between program and commercial message, a boundary between exciting scene and unexciting scene of sports event, and the like, and the boundary may be any part where the user does not feel uncomfortable even when the output of the first output data is interrupted.

With the configuration, the boundary deciding part 27 is connected to the source managing part 21 via the control line 5f.

The boundary deciding part 27 as one example of boundary deciding means decides that a data boundary preset for the first output data is a boundary of information. For example, the boundary deciding part 27 decides a boundary between videos or music in the DVD player 13 or the CD player 14 being currently played back in the content supplying apparatus 10 based on chapter information, index information, video file information, music file information, TOC (Table Of Contents) information and the like. For the digital TV tuner 11, the boundary deciding part 27 acquires information on electronic program information such as EPG via airwave or Internet and thus decides a boundary of program.

The boundary deciding part 27 acquires the information from the source managing part 21 via the control line 5a, returns the result to the source managing part 21 and reflects it on the control of the output controlling part 22. For example, the output controlling part 22 stops the output of a device which is outputting the first output data of the content A via the source managing part 21 at the boundary of the content A being currently played back.

In this manner, the output controlling part 22 as one example of the output data switching means switches the output from the first output data to the second output data based on the decision result of the boundary decision part 27.

Next, the operations of the output data switching apparatus 20A will be described with reference to the drawings.

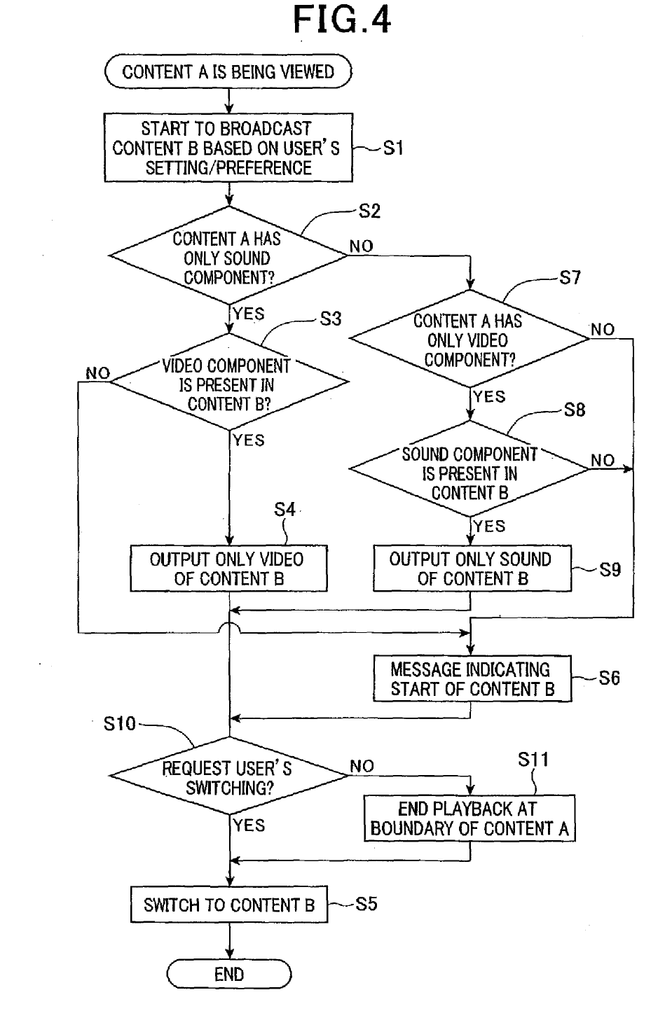

FIG. 4 is a flowchart showing exemplary operations of the output data switching apparatus 20A.

New steps are inserted between step S5 and step S4 and between step S6 and step S9 in the first embodiment.

The description of steps similar to those in the first embodiment are omitted and the newly-inserted steps will be described.

As shown in FIG. 4, the output controlling part 22 outputs the relevant information associated with the second data in step S4, step S6 or step S9, then outputs a message for asking a user's switching request and waits for user's input (step S10). For example, the relevant information associated with the second data such as only video of the content B is output and then the message for inquiring whether user's manual switching is necessary is notified.

When the manual switching is not necessary, that is, in the case of automatic switching (step S10; NO), the output controlling part 22 ends the output of the first output data at the boundary of the first output data (step S11). For example, when the boundary of the content A is reached, the content A ends to be played back at the boundary of the content A.

Then, in step S11, the output controlling part 22 ends the output of the first output data and then completely switches the output from the first output data to the second output data (step S5).

In step S10, if there is no user's input for a certain period of time, the automatic switching may be performed.

On the other hand, in the case of manual switching, after there is user's input (step S10; YES), the output controlling part 22 forcibly ends the output of the first output data and then completely switches the output to the second output data (step S5).

The present embodiment is configured such that the boundary deciding part 27 is further added to the first embodiment, and thus the contents of the first embodiment and variants thereof will be applicable.

With the above configuration, in addition to the effects of the first embodiment, the output is switched from the content A as one example of the first output data to the content B as one example of the second output data at the boundary of the information in the first output data so that the first output data is not suddenly interrupted and the first output data more smoothly transits to the second output data, thereby remarkably alleviating user's uncomfortable feeling.

When the boundary of the information in the first output data is the preset ending time of chapter information or program, the boundary deciding part 27 can more conveniently decide the boundary of the information with the simple configuration.

The boundary deciding part 27 may extract the characteristic amount of the first output data and decide the boundary of the information based on the characteristic amount. For example, the output deciding part 23 may analyze the first output data being currently played back and extract the characteristic amount, decide the starting of a commercial message, decide a boundary of program, and discriminate an exciting scene of the content or a change in scenes based on the spectrum analysis of sound or video data, and consequently decide the boundary of the content.

In this case, the boundary of data may not previously set. Even when it takes some time to reach the preset boundary of data, the output data switching apparatus 20A can switch the output to the second output data, thereby remarkably user's uncomfortable feeling due to slow switching irrespective of a notification of the switching.

Further, after a certain period of time has elapsed, a middle point of the first output data is forcibly regarded a boundary of the data and the output data may be switched to the second output data. In this case, it is preferable not to rapidly switch, for example, the sound volume is gradually reduced for the sound of the first output data, or the video is fading.

### Third Embodiment

An output data switching system according to a third embodiment of the present invention will be described below.

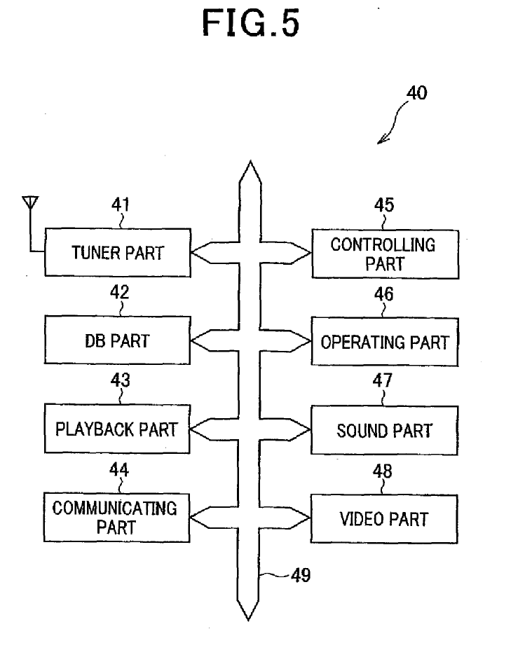

First, a schematic configuration of the output data switching system according to the third embodiment will be described with reference to FIG. 5.

FIG. 5 is a block diagram showing one example of the schematic configuration of the output data switching system according to the third embodiment. The output data switching system 40 includes a personal computer as one example, and is configured with a tuner part 41 for receiving a radio wave of terrestrial digital broadcasting or satellite digital broadcasting and extracting both sound component and video component or program information, a database (DB) part 42 such as hard disc, a playback part 43 for playing back media such as CD, a communicating part 44 for connecting to an external information network, a controlling part 45 for controlling the output data switching system 40, an operating part 46 for performing an input operation, a sound part 47 for outputting sound data, and a video part 48 for outputting video data, as shown in FIG. 5.

With the configuration, these parts are connected via a system bus 49.

The tuner part 41 is of a type of connecting to USB (Universal Serial Bus), for example.

The database part 42 has application software not only for video contents or sound contents but also for word processor, spreadsheet or web browser.

The playback part 43 is a DVD player and a CD player or their interface.

The communicating part 44 is connected to Internet, dedicated communication line (such as CATV (Community Antenna Television) line), mobile communication network (including wireless base station) and the like.

The controlling part 45 has the CPU (Central Processing Unit), the RAM (Random Access Memory), the ROM (Read Only Memory) and the like.

The operating part 46 is a keyboard or mouse, or its interface.

The sound part 47 is a speaker or its interface.

The video part 48 is a monitor or its interface.

The operations of the output data switching system 40 will be described below with reference to the drawings.

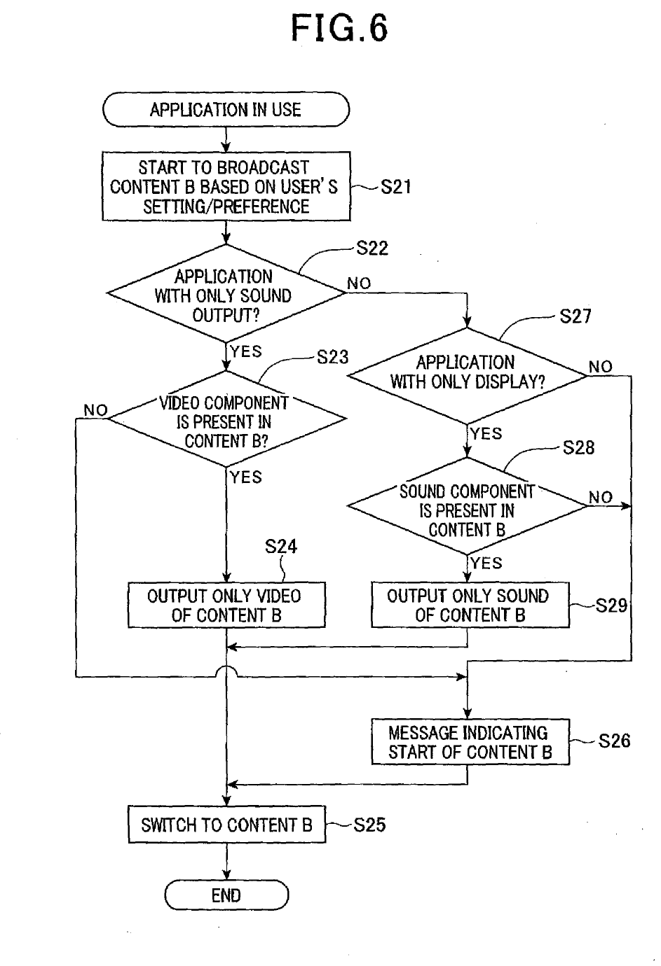

FIG. 6 is a flowchart showing exemplary operations of the output data switching system 40.

First, it is assumed that the user uses an application as one example of the first output data. For example, the user activates word processor software to create text, uses a web browser, views a slide show or listens to music content accumulated in the database part 42. When the word processor is being used, the output form of the first output data may be only the video component irrespective of alarm sound of the word processor.

Further, it is assumed that the content B as one example of the second output data is broadcast data in a user-reserved TV broadcast program.

When the user is using an application in the personal computer as one example of the output data switching system 40, the controlling part 45 as one example of the output possibility deciding means detects whether the second output data can be output (step S21). For example, the output possibility deciding means decides whether the second output data can be output based on reservation. Specifically, the controlling part 45 detects that the user-reserved broadcast content B has started or is soon starting by information from the tuner part 41, information over the Internet via the communicating part 44, or a timer inside the controlling part 45 itself.

Next, the controlling part 45 as one example of the output form deciding means decides whether the output form of the application is only the sound component (step S22). For example, a decision is made as to whether the output form of the application being currently output is only the sound component based on the states of the sound part 47 and the video part 48.

When the output form of the application is only the sound component (step S22; YES), the controlling part 45 as one example of the different component presence deciding means decides whether the video component different from the sound component is present in the content B (step S23). For example, when the output form of the application is only the sound component, the controlling part 45 decides whether the content B has the video component.

When the video component is present in the content B (step 523; YES), the controlling part 45 outputs only the video component of the content B as one example of the relevant information associated with the content B (step S24). For example, the controlling part 45 outputs only the video data from the tuner part 41 to the video part 48 while playing back music by an application for playing back music.

After a while, the output is completely switched to the content B (step S25). For example, the controlling part 45 starts to output the sound component of the content B and completely transits to the content B.

Next, when the video component is not present in the content B (step S23; NO), the controlling part 45 outputs a message indicating that the content B can be output (step S26).

For example, the controlling part 45 displays the message indicating that the content B has started or is soon starting on the monitor of the video part 48. Specifically, the message is displayed in the form of pop-up or ticker at a corner of the monitor screen or at an end of the window on which the application is opened so as not to hinder the work of the application.

After a while, the controlling part 45 switches the output to the content B (step S25).

On the other hand, when the output form of the application is not only the sound component (step S22; NO), the controlling part 45 decides whether the output form of the application is only the video component (step S27). For example, since the output form of the application is not the sound component alone but the video component alone like word processor or both the sound component and the video component like language pronunciation exercise software at this stage, the controlling part 45 discriminates the application between only the video component and both the sound component and the video component.

When the application is of only the video component (step S27; YES), the controlling part 45 as one example of the different component presence deciding means decides whether the sound component different from the video component is present in the content B (step S28).

For example, when the application is of only the video component, the controlling part 45 decides whether the content B has the sound component.

Next, when the sound component is present in the content B (step S28; YES), the controlling part 45 outputs only the sound component of the content B as one example of the relevant information associated with the content B (step S29). For example, when the application is word processor or the like and the content B is a documentary program or the like, the controlling part 45 outputs only the sound component of the content B from the speaker of the sound part 47 while the application is being used.

After a while, the controlling part 45 completely switches the output to the content B (step S5). For example, the controlling part 45 starts to output the video component of the content B and completely transits to the content B.

Next, when the output form of the application is both the sound component and the video component (step S27; NO) or when the sound component is not present in the content B (step S28; NO), the controlling part 45 outputs the message indicating that the content B can be output (step S26).

After a while, the controlling part 45 switches the output to the content B (step S25).

The present embodiment is different from the first embodiment and the second embodiment in that the first output data is an application instead of the content A, and thus the contents of the first embodiment or the second embodiment and its variants are applicable.

When the user is working the application while listening to background music on a personal computer, for example, when the user is working while playing back Internet radio or music file, the sound data is not main but sub and thus may be notified by the sound component of the second output data.

The embodiments according to the present invention may be in the form of a program for the output data switching apparatus characterized in that a computer contained in the output data switching system 40 or the like, for example, a personal computer according to the present embodiment is caused to function as relevant information outputting means, switching means and the like.

In a portable wireless telephone, the present embodiment is applicable when a reserved broadcast program starts while an electronic mail is being created by an application or information over the Internet is being retrieved or read.

Further, the present invention is not limited to the above embodiments. The above embodiments are exemplary and have any form of substantially the same configuration as the technical spirit described in claims, and similar operational effects are encompassed within the technical range of the present invention.

1-17. (canceled)

18. An output data switching apparatus for switching an output of output data made of at least one of a sound component and a video component from a first output data being output to a second output data, comprising:
a relevant information outputting device which outputs relevant information associated with the second output data simultaneously with and in parallel with the first output data being output based on an output form of the first output data and an output form of the second output data; and
a switching device which switches the output from the first output data to the second output data after a lapse of a transition time after the relevant information is output.

19. The output data switching apparatus according to claim 18,
wherein the relevant information outputting device outputs either the sound component or the video component constituting the second output data as the relevant information.

20. The output data switching apparatus according to claim 18, further comprising:
an output form deciding device which decides whether the output form of the first output data is a single component; and
a different component presence deciding device which, in the case of the single component, decides whether a different component from the single component is present in the second output data,
wherein, when the different component is present, the relevant information outputting device outputs the second output data by only the different component.

21. The output data switching apparatus according to claim 18,
wherein, when the output form of the second output data is an output form where a remaining component obtained by removing the component of the first output data from the components of the second output data is present, the relevant information outputting device outputs the second output data by only the remaining component.

22. The output data switching apparatus according to claim 20, further comprising: an output possibility deciding device which decides whether the second output data can be output,
wherein, when the second output data can be output based on the output possibility deciding device, the relevant information outputting device outputs a message indicating that the second output data can be output.

23. The output data switching apparatus according to claim 22, wherein the relevant information outputting device changes at least one of amplitude and frequency of the first output data to output the message.

24. The output data switching apparatus according to claim 22,
wherein the relevant information outputting device outputs either the sound component or the video component constituting the second output data as the relevant information, and then outputs the message.

25. The output data switching apparatus according to claim 22, further comprising:
an output form deciding device which decides whether the output form of the first output data is the single component; and
a different component presence deciding device which, in the case of the single component, decides whether a different component from the single component is present in the second output data,
wherein, when the different component is not present, the relevant information outputting device outputs the message.

26. The output data switching apparatus according to claim 22,
wherein the output possibility deciding device decides whether the second output data can be output based on reservation.

27. The output data switching apparatus according to claim 22,
wherein the output possibility deciding device decides whether the second output data can be output depending on a result obtained by retrieving the second output data capable of being output based on user's preference information.

28. The output data switching apparatus according to clam 18, further comprising:
a boundary deciding device which decides a boundary of information associated with the first output data,
wherein the output data switching device switches the output from the first output data to the second output data based on a decision result of the boundary deciding device.

29. The output data switching apparatus according to claim 28,
wherein the boundary deciding device decides that a preset boundary of data for the first output data is a boundary of the information.

30. The output data switching apparatus according to claim 28,
wherein the boundary deciding device extracts the characteristic amount of the first output data, and decides a boundary of the information based on the characteristic amount.

31. An output data switching method of switching an output of output data made of at least one of a sound component and a video component from a first output data being output to a second output data, comprising:
a first output data's output form deicing process of deciding an output form of the first output data;
a second output data's output form deciding process of deciding an output form of the second output data;
a relevant information outputting process of outputting relevant information associated with the second data simultaneously with and in parallel with the first output data being output based on decision results of the first output data's output form deciding process and the second output data's output form deciding process; and
a switching process of switching the output from the first output data to the second output data after a lapse of a transition time after the relevant information is output.

32. The output data switching method according to claim 31,
wherein the first output data's output form deciding process decides whether the output form of the first output data is a single component;
in the case of the single component, the second output data's output form deciding step decides whether a different component from the single component is present in the second output data; and
when the different component is present, the relevant information outputting means outputs the second output data by only the different component.

33. An output data switching system, comprising: the output data switching apparatus according to claim 18; and
a plurality of output data source apparatuses as a source for supplying an output data,
wherein an output data from the output data source apparatus is switched by the output data switching apparatus, and is output.

34. A non-transitory computer-readable recording medium in which a program for an output data switching apparatus is recorded, the program causing a computer contained in the output data switching apparatus according to claim 18 to function as the relevant information outputting device and the switching device.
